(19) United States
(12) Patent Application Publication
(10) Pub. No.: US 2023/0022950 A1
(43) Pub. Date: Jan. 26, 2023

(54) ENERGY STORAGE DEVICE

(71) Applicant: GS YUASA INTERNATIONAL LTD., Kyoto-shi, Kyoto (JP)

(72) Inventors: Kenta OGI, Kyoto-shi, Kyoto (JP); Kei KUMABAYASHI, Kyoto-shi, Kyoto (JP); Akihiko MIYAZAKI, Kyoto-shi, Kyoto (JP)

(21) Appl. No.: 17/787,448

(22) PCT Filed: Dec. 22, 2020
(86) PCT No.: PCT/JP2020/047838

§ 371 Date: Jun. 20, 2022

(30) Foreign Application Priority Data
Dec. 23, 2019 (JP) 2019-232142
Dec. 23, 2019 (JP) 2019-232144
Dec. 23, 2019 (JP) 2019-232146

(51) Int. Cl. H01M 4/133; H01M 4/587; H01M 4/505; H01M 4/525; H01M 4/131; H01M 4/62; H01M 50/491; H01M 10/0587; H01G 11/32; H01G 11/46

(52) U.S. Cl. CPC H01M 4/133; H01G 11/32; H01G 11/46; H01M 4/62; H01M 4/131; H01M 4/505; H01M 4/525; H01M 4/587; H01M 10/0587; H01M 50/491; H01M 2004/027

(57) ABSTRACT

An energy storage device according to one aspect of the present invention includes: a negative electrode including a negative electrode substrate and a negative active material layer layered directly or indirectly on a surface of the negative electrode substrate; and a positive electrode. The negative active material layer contains a negative active material. The negative active material contains non-graphitizable carbon. In one direction of the negative electrode substrate, at least one end edge side of the negative active material layer is thicker than a central portion present between the one end edge side and the other end edge side facing the one end edge side. When a true density of the non-graphitizable carbon is A [g/cm³], an amount of charge B [mAh/g] of the negative electrode in a fully charged state satisfies the following formula 1.

$$- 173 \text{XA+1588} \leq \text{B} \leq \text{-830A+1800}$$

### TECHNICAL FIELD

The present invention relates to an energy storage device.

The present international application claims priority based on Japanese Patent Application No. 2019-232142 filed on Dec. 23, 2019, Japanese Patent Application No. 2019-232144 filed on Dec. 23, 2019, and Japanese Patent Application No. 2019-232146 filed on Dec. 23, 2019, the entire contents of which are incorporated herein by reference.

### BACKGROUND ART

Nonaqueous electrolyte secondary batteries typified by lithium ion nonaqueous electrolyte secondary batteries are widely in use for electronic equipment such as personal computers and communication terminals, automobiles, and the like because the batteries have high energy density. The nonaqueous electrolyte secondary battery is generally provided with an electrode assembly, having a pair of electrodes electrically isolated by a separator, and a nonaqueous electrolyte interposed between the electrodes and is configured to charge and discharge by transferring ions between both the electrodes. Capacitors such as lithium ion capacitors and electric double-layer capacitors are also widely in use as energy storage devices except for the nonaqueous electrolyte secondary batteries.

As an active material of a negative electrode of such an energy storage device, carbon materials such as graphite, non-graphite carbon, and amorphous carbon are widely used. For example, for the purpose of increasing the capacity of the energy storage device, a lithium ion secondary battery using non-graphitizable carbon having a large chargeable/dischargeable capacity per unit mass as a negative active material has been proposed (see Patent Document 1).

### PRIOR ART DOCUMENT

### Patent Document

Patent Document 1: JP-A-07-335262

### SUMMARY OF THE INVENTION

### Problems to Be Solved by the Invention

However, when the depth of charge of the negative electrode is increased by using non-graphitizable carbon as the negative active material for the purpose of increasing the capacity of the battery, the potential of the negative electrode becomes low, whereby the deposition of metallic lithium during charge may cause deterioration in durability (for example, a decrease in a capacity retention ratio or an increase in resistance after a charge-discharge cycle). Therefore, there is a demand for an energy storage device capable of improving durability even when non-graphitizable carbon is used as a negative active material of a battery including a negative electrode having a large depth of charge for the purpose of increasing the capacity.

The present invention has been made in view of the above circumstances, and an object of the present invention is to provide an energy storage device capable of improving durability when non-graphitizable carbon is used for an active material of a negative electrode having a large depth of charge.

### Means for Solving the Problems

An aspect of the present invention made to solve the above problems is an energy storage device including: a negative electrode including a negative electrode substrate and a negative active material layer layered directly or indirectly on a surface of the negative electrode substrate; and a positive electrode, wherein the negative active material layer contains a negative active material; the negative active material contains non-graphitizable carbon; in one direction of the negative electrode substrate, at least one end edge side of the negative active material layer is thicker than a central portion present between the one end edge side and the other end edge side; and when a true density of the non-graphitizable carbon is A [g/cm³], an amount of charge B [mAh/g] of the negative electrode in a fully charged state satisfies the following formula 1:

$$\text{-} 730 \times \text{A+1588} \leq \text{B} \leq \text{-830} \times \text{A+1800}$$

### Advantages of the Invention

According to the present invention, it is possible to provide an energy storage device capable of improving durability when non-graphitizable carbon is used for an active material of a negative electrode having a large depth of charge.

### BRIEF DESCRIPTION OF THE DRAWINGS

FIG. 1 is a schematic perspective view showing the configuration of an energy storage device of one embodiment of the present invention.

FIG. 2 is a schematic exploded perspective view showing a positive electrode, a negative electrode, and a separator constituting an electrode assembly of FIG. 1.

FIG. 3 is a schematic cross-sectional view of the negative electrode constituting the electrode assembly of FIG. 1.

FIG. 4 is a schematic view showing an energy storage apparatus configured by aggregating a plurality of energy storage devices in one embodiment of the present invention.

FIG. 5 is a graph showing a relationship between the true density of non-graphitizable carbon in a negative active material and the amount of charge of a negative electrode in a fully charged state in Test Examples.

FIG. 6 is a graph showing a relationship between the true density of non-graphitizable carbon in a negative active material and the amount of charge of a negative electrode in a fully charged state in Test Examples.

FIG. 7 is a graph showing a relationship between the true density of non-graphitizable carbon in a negative active material and the amount of charge of a negative electrode in a fully charged state in Test Examples.

### MODE FOR CARRYING OUT THE INVENTION

### First Aspect

As a result of various experiments, the present inventors have realized that there is a certain correlation between the true density A of non-graphitizable carbon contained in a negative active material layer and the amount of charge supports (in the case of a lithium ion secondary battery, lithium ions) that can be occluded while the deposition of the charge supports on the non-graphitizable carbon is suppressed (amount of charge B), and have found that the deposition of the charge support can be more effectively suppressed by devising the shape of the end portion of the negative active material layer, thereby completing a first aspect of the present invention.

That is, an energy storage device according to a first aspect of the present invention includes: a negative electrode including a negative electrode substrate and a negative active material layer layered directly or indirectly on a surface of the negative electrode substrate; and a positive electrode, wherein the negative active material layer contains a negative active material; the negative active material contains non-graphitizable carbon; in one direction of the negative electrode substrate, at least one end edge side of the negative active material layer is thicker than a central portion present between the one end edge side and the other end edge side; and when a true density of the non-graphitizable carbon is A [g/cm³], an amount of charge B [mAh/g] of the negative electrode in a fully charged state satisfies the following formula 1:

$$\text{-} 730 \times \text{A} + 1588 \leq \text{B} \leq \text{-} 830 \times \text{A} + 1800$$

The durability of the energy storage device according to the first aspect can be improved when non-graphitizable carbon is used for an active material of a negative electrode having a large depth of charge. Although the reason for this is not clear, the following reason is presumed.

That is, when the amount of charge in the fully charged state of the negative electrode increases, the amount of the charge supports occluded in the negative active material per unit mass during charge increases. Therefore, the charge supports that have not entered the negative active material during charge may be deposited on the negative electrode. In particular, at least on the end edge side of the negative active material layer, the amount of the charge supports occluded in the negative active material per unit mass locally increases, whereby the charge supports are apt to be deposited.

Meanwhile, in the energy storage device according to the first aspect, when the true density of the non-graphitizable carbon is A [g/cm³], the amount of charge B [mAh/g] of the negative electrode in the fully charged state is -830 × A+ 1800 or less, so that the amount of charge B has an appropriate size, which makes it possible to suppress the occurrence of excessive deposition of the charge supports. In the range where the amount of charge B of the negative electrode is -730 × A + 1588 or more, at least one end edge side of the negative active material layer is thicker than the central portion present between the one end edge side and the other end edge side, so that more charge supports can be occluded on the end edge side of the negative active material layer in which the deposition of the charge supports is particularly apt to occur than on the central portion.

Therefore, in the energy storage device according to the first aspect, the amount of charge B of the negative electrode in the fully charged state falls within a specific range satisfying the above formula 1, whereby the deposition of the charge supports can be suppressed even when the amount of charge B is relatively large, and as a result, the durability of the energy storage device can be improved.

Here, in the present specification, the “fully charged state” refers to a state where the energy storage device is charged with electricity until reaching a rated upper limit voltage for securing a rated capacity determined by battery design. When the rated capacity is not described, the “fully charged state” refers to a state where the energy storage device is charged with electricity using a charge control device adopted by the energy storage device, and the energy storage device is charged with electricity until reaching an end-of-charge voltage when the charge operation is controlled to be stopped. For example, a state where the energy storage device is subjected to constant current charge with a current of (⅓) CA until reaching the rated upper limit voltage or the end-of-charge voltage, and then subjected to constant current constant voltage charge (CCCV) until reaching 0.01 CA with the rated upper limit voltage or the end-of-charge voltage is a typical example of the “fully charged state” referred to herein.

A thickness difference (T2-T1) between a thickness T2 of the negative active material layer on the one end edge side and a thickness T1 of the central portion is preferably 1 µm or more and 5 µm or less. When the thickness difference (T2-T1) is 1 µm or more and 5 µm or less, the deposition of the charge supports can be more effectively suppressed. Accordingly, the durability of the energy storage device according to the first aspect can be further improved.

It is preferable that the negative electrode substrate includes a non-layered portion which protrudes from the one end edge side and on which the negative active material layer is not layered, and a thickness T2 of the negative active material layer on the non-layered portion side is greater than a thickness T3 of the negative active material layer on the other end edge side. When the thickness T2 of the negative active material layer on the non-layered portion side is greater than the thickness T3 of the negative active material layer on the other end edge side, the deposition of the charge supports can be more effectively suppressed. Accordingly, the durability of the energy storage device according to the first aspect can be further improved.

It is preferable that the positive electrode includes a positive electrode substrate and a positive active material layer directly or indirectly layered on a surface of the positive electrode substrate; the positive active material layer contains a positive active material; the positive active material contains a lithium transition metal oxide containing nickel, cobalt, and manganese as a main component; and a molar ratio of nickel to a total of nickel, cobalt, and manganese in the lithium transition metal oxide is 0.5 or more. As described above, in an aspect in which the positive active material contains a lithium transition metal oxide having a high Ni ratio, the above-described effect can be more effectively exhibited.

### Second Aspect

As a result of various experiments, the present inventors have realized that there is a certain correlation between the true density A of non-graphitizable carbon contained in a negative active material layer and the amount of charge supports that can be occluded while the deposition of charge supports (in the case of a lithium ion secondary battery, lithium ions) on the non-graphitizable carbon is suppressed (amount of charge B), and have found that by setting the range of the porosity of a separator to an appropriate range, a decrease in a capacity retention ratio after a charge-discharge cycle can be more effectively suppressed, thereby completing a second aspect of the present invention.

That is, an energy storage device according to the second aspect of the present invention includes: a negative electrode including a negative active material layer containing a negative active material; a positive electrode including a positive active material layer containing a positive active material; and a separator interposed between the negative electrode and the positive electrode, wherein a porosity of the separator is 50% or more; the negative active material contains non-graphitizable carbon as a main component; and when a true density of the non-graphitizable carbon is A [g/cm³], an amount of charge B [mAh/g] of the negative electrode in a fully charged state satisfies the following formula 2:

$$\text{-} 660 \times \text{A} + 1433 \leq \text{B} \leq \text{-} 830 \times \text{A} + 1800$$

When the non-graphitizable carbon is used as the active material of the negative electrode having a large depth of charge for the purpose of increasing the capacity, a decrease in the capacity retention ratio of the energy storage device according to the second aspect after a charge-discharge cycle can be suppressed. Although the reason for this is not clear, the following reason is presumed. When the non-graphitizable carbon is used as the active material of the negative electrode, and the depth of charge of the negative electrode is increased, a negative electrode potential is shifted to a lower level, whereby charge supports may be apt to be deposited. In the energy storage device according to the second aspect, when the true density of the non-graphitizable carbon is A [g/cm³], the amount of charge B [mAh/g] of the negative electrode in the fully charged state is -830 × A+ 1800 or less, so that the amount of charge B has an appropriate size, which makes it possible to suppress the occurrence of excessive deposition of the charge supports. When the amount of charge B of the negative electrode is in the range of -660 × A + 1433 or more, the porosity of the separator is 50% or more, so that the migration resistance of the charge supports in the separator can be reduced, and therefore the potential of the negative electrode can be kept relatively noble. Therefore, the deposition of the charge supports can be suppressed, which accordingly makes it possible to suppress the decrease in the capacity retention ratio after the charge-discharge cycle.

The true density A of the non-graphitizable carbon is preferably 1.5 g/cm³ or less. When the true density A of the non-graphitizable carbon is in the above range, the amount of lithium ions that can be occluded between the crystal structures of the non-graphitizable carbon can be set to a good range.

It is preferable that the positive active material contains a lithium transition metal oxide containing nickel, cobalt, and manganese as a main component, and the molar ratio of nickel to the total of nickel, cobalt, and manganese in the lithium transition metal oxide is 0.5 or more. By setting the molar ratio of nickel to the total of nickel, cobalt, and manganese in the lithium transition metal oxide within the above range, the capacity retention ratio of the energy storage device according to the second aspect after a charge-discharge cycle can be increased.

### Third Aspect

As a result of various experiments, the present inventors have realized that there is a certain correlation between the true density A of non-graphitizable carbon contained in a negative active material layer and the amount of charge supports (in the case of a lithium ion secondary battery, lithium ions) that can be occluded while the deposition of the charge supports on the non-graphitizable carbon is suppressed (amount of charge B), and have found that the deposition of the charge supports can be more effectively suppressed by appropriately selecting the binder of the negative active material layer, thereby completing a third aspect of the present invention.

That is, an energy storage device according to the third aspect of the present invention includes: a negative electrode including a negative active material layer containing a negative active material; and a positive electrode including a positive active material layer containing a positive active material, wherein the negative active material layer contains a cellulose derivative in which a counter cation is a metal ion; the negative active material contains non-graphitizable carbon as a main component; and when a true density of the non-graphitizable carbon is A [g/cm³], an amount of charge B [mAh/g] of the negative electrode in a fully charged state satisfies the following formula 3:

$$\text{-} 580 \times \text{A} + 1258 \leq \text{B} \leq \text{-} 830 \times \text{A} + 1800$$

The energy storage device according to the third aspect suppresses the deposition of the charge supports when the non-graphitizable carbon is used for the active material of the negative electrode having a large depth of charge for the purpose of increasing the capacity, and is excellent in an effect of suppressing an increase in resistance after a charge-discharge cycle. Although the reason for this is not clear, the following reason is presumed. When the non-graphitizable carbon is used as the active material of the negative electrode, and the depth of charge of the negative electrode is increased, a negative electrode potential is shifted to a lower level, whereby charge supports may be apt to be deposited. In the energy storage device according to the third aspect, when the true density of the non-graphitizable carbon is A [g/cm³], the amount of charge B [mAh/g] of the negative electrode in the fully charged state is -830 × A + 1800 or less, so that the amount of charge B has an appropriate size, which makes it possible to suppress the occurrence of excessive deposition of the charge supports. Meanwhile, when the amount of charge B [mAh/g] of the negative electrode is in the range of -580 × A+ 1258 or more, an increase in resistance after a charge-discharge cycle can be suppressed by using, as a binder of the negative active material layer, a cellulose derivative in which a counter cation that is excellent in reduction resistance and is considered to be less likely to be reductively decomposed even in a state where a negative electrode potential is low is a metal ion. Therefore, the energy storage device according to the third aspect is excellent in an effect of suppressing the increase in resistance after the charge-discharge cycle when the non-graphitizable carbon is used as the active material of the negative electrode having a large depth of charge.

The metal ion is preferably a sodium ion. When the metal ion is the sodium ion, the effect of suppressing the increase in resistance after the charge-discharge cycle can be further improved.

It is preferable that the positive active material contains a lithium transition metal oxide containing nickel, cobalt, and manganese as a main component, and the molar ratio of nickel to the total of nickel, cobalt, and manganese in the lithium transition metal oxide is 0.5 or more. By setting the molar ratio of nickel to the total of nickel, cobalt, and manganese in the lithium transition metal oxide within the above range, the capacity of the energy storage device according to the third aspect can be increased, and the above effect can be more effectively exhibited.

The first aspect, the second aspect, and the third aspect can be appropriately used in combination. As a suitable example of the energy storage device disclosed herein, the energy storage device includes: a negative electrode including a negative electrode substrate and a negative active material layer directly or indirectly layered on a surface of the negative electrode substrate; and a positive electrode, wherein the negative active material layer contains a negative active material; the negative active material contains non-graphitizable carbon; at least one end edge side of the negative active material layer is thicker than a central portion present between the one end edge side and the other end edge side in one direction of the negative electrode substrate; and when a true density of the non-graphitizable carbon is A [g/cm³], an amount of charge B [mAh/g] of the negative electrode in a fully charged state satisfies the above formula 1. The energy storage device may include a separator interposed between the negative electrode and the positive electrode. The porosity of the separator may be 50% or more. The negative active material layer may contain a cellulose derivative in which a counter cation is a metal ion. Hereinafter, the energy storage device according to an embodiment of the present invention will be described in detail with reference to the drawings.

### Energy Storage Device

An energy storage device according to an embodiment of the present invention includes a negative electrode, a positive electrode, a separator interposed between the negative electrode and the positive electrode, and a nonaqueous electrolyte. Hereinafter, a nonaqueous electrolyte secondary battery (particularly, a lithium ion secondary battery) will be described as a preferable example of the energy storage device, but it is not intended to limit the application target of the present invention. The negative electrode and the positive electrode usually form an electrode assembly in which the positive electrode and the negative electrode are alternately superposed by being layered or wound with the separator interposed therebetween. The electrode assembly is housed in a battery case, and the battery case is filled with the nonaqueous electrolyte. The nonaqueous electrolyte is interposed between the positive electrode and the negative electrode. As the battery case, a known metal battery case or resin battery case or the like which is usually used as a battery case of a nonaqueous electrolyte secondary battery can be used.

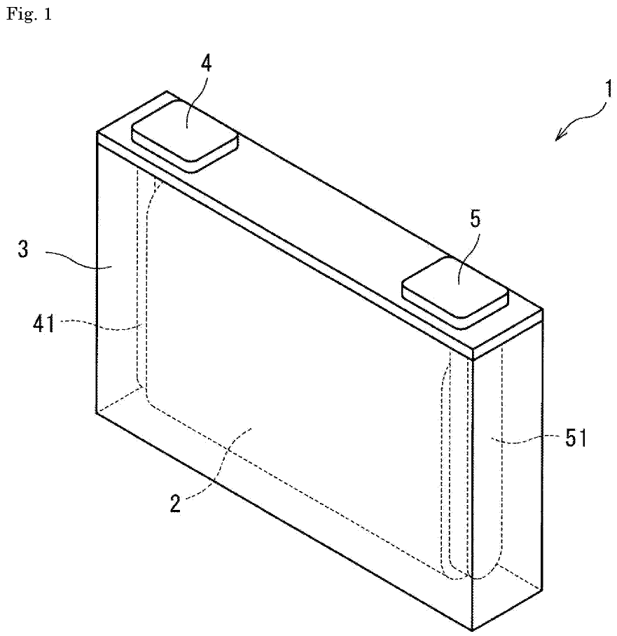

FIG. 1 shows the outline of a rectangular energy storage device 1 (nonaqueous electrolyte secondary battery) as an embodiment of the present invention. FIG. 1 is a view showing the inside of a battery case 3 in a perspective manner. An electrode assembly 2 including a negative electrode and a positive electrode which are wound with a separator interposed therebetween is housed in a prismatic battery case 3. The negative electrode is electrically connected to a negative electrode terminal 5 via a negative current collector 51. The positive electrode is electrically connected to a positive electrode terminal 4 via a positive current collector 41. A nonaqueous electrolyte is injected in the battery case 3.

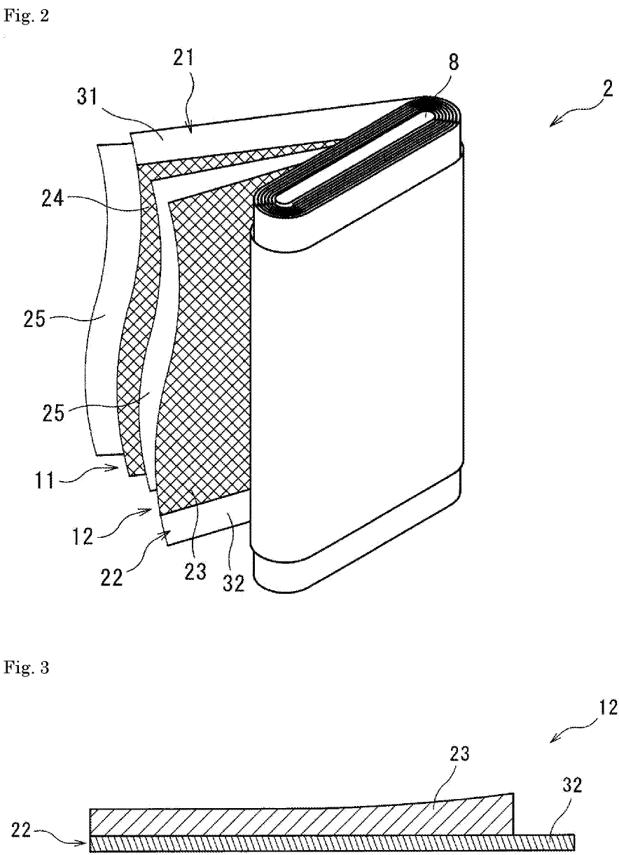

FIG. 2 is a schematic view schematically showing the electrode assembly 2 of the energy storage device 1. As shown in FIG. 2, the electrode assembly 2 is a wound electrode assembly in which a rectangular sheet assembly including a positive electrode 11, a negative electrode 12 and a separator 25 is wound in a flat shape around a winding core 8. The electrode assembly 2 is formed by winding the negative electrode 12 and the positive electrode 11 in a flat shape with the separator 25 interposed therebetween. That is, in the electrode assembly 2, the strip-shaped separator 25 is layered on the periphery side of the strip-shaped negative electrode 12. The strip-shaped positive electrode 11 is layered on the periphery side of the separator 25. Furthermore, the strip-shaped separator 25 is layered on the periphery side of the positive electrode 11. The negative electrode 12 includes a negative electrode substrate 22 and a negative active material layer 23. The negative active material layer 23 contains a negative active material. The negative active material layer 23 is layered on at least one surface of the negative electrode substrate 22 directly or indirectly with an intermediate layer interposed therebetween. The positive electrode 11 includes a rectangular positive electrode substrate 21 and a positive active material layer 24. The positive active material layer 24 contains a positive active material. The positive active material layer 24 is layered on at least one surface of the positive electrode substrate 21 directly or indirectly with an intermediate layer interposed therebetween.

In the electrode assembly 2 configured as described above, more specifically, the negative electrode 12 and the positive electrode 11 are wound with the separator 25 interposed therebetween while being shifted from each other in the winding axis direction. The negative electrode substrate 22 includes a negative electrode non-layered portion 32 which protrudes from one end edge side of the negative active material layer 23 and on which the negative active material layer 23 is not layered. Meanwhile, the negative electrode substrate 22 does not protrude from the other end edge side facing the one end edge side of the negative active material layer 23. The positive electrode substrate 21 includes a positive electrode non-layered portion 31 which protrudes from the other end edge side facing the one end edge side of the negative active material layer 23 and on which the positive active material layer 24 is not layered. Meanwhile, the positive electrode substrate 21 does not protrude from one end edge side of the negative active material layer 23. With such a configuration, the electrode assembly 2 includes a positive-electrode-side end portion where the positive electrode substrate 21 of the positive electrode 11 is layered on one end edge side in the winding axis direction, and includes a negative-electrode-side end portion where the negative electrode substrate 22 of the negative electrode 12 is layered on the other end edge side in the winding axis direction.

FIG. 3 is a schematic cross-sectional view of the negative electrode 12. As shown in FIG. 3, at least one end edge side of the negative active material layer 23 is thicker than a central portion present between the one end edge side and the other end edge side. The at least one end edge side of the negative active material layer 23 is thicker than the central portion present between the one end edge side and the other end edge side, which makes it possible to suppress the positive electrode 11 from being shifted in the end edge direction when vibration in the vertical direction is applied to the battery case 3.

Although not particularly limited, when the length in one direction (that is, the width direction from one end edge side to the other end edge side) of the negative active material layer 23 is W, a thickness T1 of the central portion of the negative active material layer 23 can be determined by measuring a thickness in a region of 0.4 W or more and 0.6 W or less from the end edge on one end edge side of the negative active material layer 23 and arithmetically averaging a plurality of (for example, five) measured values. A thickness T2 of the negative active material layer 23 on the one end edge side can be determined, for example, by measuring a thickness at a position of 2 mm from the end edge of the negative active material layer 23 on the one end edge side toward the central portion and arithmetically averaging a plurality of (for example, five) measured values. The thickness T3 of the negative active material layer 23 on the other end edge side can be determined, for example, by measuring a thickness at a position of 2 mm from the end edge of the negative active material layer 23 on the other end edge side toward the central portion side and arithmetically averaging a plurality of (for example, five) measured values. When the negative active material layer 23 is formed on each of both surfaces of the negative electrode substrate 22, T1, T2, and T3 are values obtained by adding the thicknesses of the negative active material layers on both the surfaces.

The thickness T1 of the central portion of the negative active material layer 23 is not particularly limited as long as the thickness T1 and the thickness T2 of the negative active material layer 23 on one end edge side satisfy a relationship of T1 < T2. The thickness T1 of the central portion of the negative active material layer 23 is suitably, for example, 50 µm or more, usually 70 µm or more, and typically 80 µm or more. T1 is preferably 90 µm or more, more preferably 100 µm or more, and still more preferably 110 µm or more. In some aspects, T1 may be 115 µm or more or 120 µm or more. T1 may be, for example, 250 µm or less. T1 is preferably 200 µm or less, more preferably 180 µm or less, and still more preferably 160 µm or less. In some aspects, T1 may be 150 µm or less or 140 µm or less.

The thickness T2 of the negative active material layer 23 on one end edge side is not particularly limited as long as the thickness T2 and the thickness T1 of the central portion of the negative active material layer 23 satisfy a relationship of T1 < T2. In a preferable aspect, a thickness difference (T2-T1) between the thickness T2 of the negative active material layer 23 on one end edge side and the thickness T1 of the central portion of the negative active material layer 23 is 0.5 µm or more. The thickness difference (T2-T1) is preferably 0.8 µm or more, and more preferably 1 µm or more. In some aspects, the difference (T2-T1) may be 2 µm or more or 2.5 µm or more. The difference (T2-T1) is suitably about 10 µm or less, and preferably 5 µm or less. In some aspects, the difference (T2-T1) may be 4 µm or less or 3 µm or less. The technique disclosed herein can be preferably carried out in an aspect in which the difference in thickness (T2-T1) between the one end edge side and the central portion of the negative active material layer 23 is 0.5 µm or more and 10 µm or less (further, 1 µm or more and 5 µm or less). When the thickness difference (T2-T1) is within the above range, the deposition of metallic lithium can be more efficiently suppressed. Accordingly, the durability of the energy storage device 1 can be further improved.

The thickness T3 of the negative active material layer 23 on the other end edge side is not particularly limited. The thickness T3 of the negative active material layer 23 on the other end edge side may be the same as or different from the thickness T1 of the central portion of the negative active material layer 23 (for example, T3 > T1). In this embodiment, the thickness T3 of the negative active material layer 23 on the other end edge side is substantially the same as the thickness T1 of the central portion of the negative active material layer 23. In a preferable aspect, the thickness T2 of the negative active material layer 23 on the negative electrode non-layered portion 32 side is greater than the thickness T3 on the other end edge side (T2 > T3). The thickness of the end edge of the negative active material layer 23 on the negative electrode non-layered portion 32 side is apt to decrease (as a result, the amount of lithium ions occluded in the negative active material per unit mass is apt to locally increase) as compared with the central portion due to dripping or the like at the time of applying the negative composite paste described later, and the deposition of metallic lithium is particularly apt to occur. Meanwhile, according to the above configuration, such inconvenience can be eliminated or alleviated on the negative electrode non-layered portion 32 side of the negative active material layer 23 where the deposition of metallic lithium is apt to occur.

### Negative Electrode

As described above, the negative electrode 12 includes the negative electrode substrate 22 and the negative active material layer 23.

### Negative Electrode Substrate

The negative electrode substrate 22 is a substrate having conductivity. As the material of the negative electrode substrate 22, a metal such as copper, nickel, stainless steel, or nickel-plated steel, or an alloy thereof is used, and copper or a copper alloy is preferable. Examples of the form of the negative electrode substrate 22 include a foil, and a vapor deposition film, and a foil is preferable from the viewpoint of cost. That is, the negative electrode substrate 22 is preferably a copper foil. Examples of the copper foil include a rolled copper foil and an electrolytic copper foil. Note that having “conductivity” means that the volume resistivity measured in accordance with JIS-H-0505 (1975) is 1 × 10⁷ Ω·cm or less, and “nonconductive” means that the volume resistivity is more than 1 × 10⁷ Ω·cm.

The average thickness of the negative electrode substrate 22 is preferably 2 µm or more and 35 µm or less, more preferably 3 µm or more and 25 µm or less, still more preferably 4 µm or more and 20 µm or less, and particularly preferably 5 µm or more and 15 µm or less. When the average thickness of the negative electrode substrate 22 is within the above-described range, it is possible to increase the energy density per volume of the energy storage device 1 while increasing the strength of the negative electrode substrate 22. The “average thickness of a substrate” refers to a value obtained by dividing the cutout mass in cutout of a substrate having a predetermined area by the true density and cutout area of the substrate.

### Negative Active Material Layer

The negative active material layer 23 is formed of a so-called negative composite containing a negative active material.

The negative active material contains non-graphitizable carbon. When the negative active material contains the non-graphitizable carbon, the capacity of the energy storage device 1 can be increased. The negative composite may contain other negative active materials except for the non-graphitizable carbon. The “main component in the negative active material” refers to a component having the highest content, and refers to a component contained in an amount of 90% by mass or more with respect to the total mass of the negative active material.

### Non-Graphitizable Carbon

The non-graphitizable carbon is a carbon substance in which an average grid plane spacing d(002) of a (002) plane measured by an X-ray diffraction method in a discharge state is more than 0.36 nm and less than 0.42 nm. The non-graphitizable carbon usually refers to a material in which minute graphite crystals are arranged in a random direction, and nano-order voids are present between crystal layers. Examples of the non-graphitizable carbon include a phenol resin fired body, a furan resin fired body, and a furfuryl alcohol resin fired body.

Here, the “discharged state” refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The true density A of the non-graphitizable carbon is not particularly limited as long as the relationship between the true density A and the amount of charge B satisfies the above formula, but the lower limit thereof is preferably 1.4 g/cm³, and more preferably 1.45 g/cm³. In some aspects, the true density A may be 1.5 g/cm³ or more, 1.55 g/cm³ or more, or 1.6 g/cm³ or more. The upper limit of the true density is preferably 1.8 g/cm³, and more preferably 1.7 g/cm³. In some aspects, the true density A may be 1.65 g/cm³ or less, 1.58 g/cm³ or less, or 1.52 g/cm³ or less. If the true density of the non-graphitizable carbon is too small, impurities derived from raw materials and reaction active surfaces increase, whereby the irreversible capacity increases. If the true density is too large, the amount of lithium ions that can be occluded between crystal structures decreases. That is, the above range makes it possible to increase the amount of lithium ions that can be occluded while suppressing the irreversible capacity. The true density is measured by a pycnometer method using butanol.

The lower limit of the content of the non-graphitizable carbon with respect to the total mass of the negative active material is preferably 50% by mass (for example. 75% by mass, typically 90% by mass). By setting the content of the non-graphitizable carbon to be equal to or greater than the above lower limit, the capacity retention ratio of the energy storage device after a charge-discharge cycle can be further increased. Meanwhile, the upper limit of the content of the non-graphitizable carbon with respect to the total mass of the negative active material may be, for example, 100% by mass.

### (Other Negative Active Materials)

Examples of other negative active materials that may be contained in addition to the non-graphitizable carbon include easily graphitizable carbon, graphite, metals such as Si and Sn, oxides of these metals, and composites of these metals and carbon materials.

The content of the negative active material in the negative active material layer is not particularly limited, but the lower limit thereof is preferably 50% by mass, more preferably 80% by mass, and still more preferably 90% by mass. Meanwhile, the upper limit of the content is preferably 99% by mass, and more preferably 98% by mass.

### (Other Optional Components)

The negative composite contains optional components such as a conductive agent, a thickener, and a filler as necessary.

The non-graphitizable carbon also has conductivity, but the conductive agent is not particularly limited as long as it is a conductive material. Examples of such a conductive agent include graphite, carbonaceous materials, metals, and conductive ceramics. Examples of the carbonaceous materials include non-graphitized carbon and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly or two or more of these materials may be used in mixture. These materials may be composited and used. For example, a material obtained by compositing carbon black with CNT may be used. Among these, carbon black is preferable from the viewpoint of electron conductivity and coatability, and in particular, acetylene black is preferable.

As the binder, either an aqueous binder or a nonaqueous binder can be used, but the aqueous binder is preferable. The aqueous binder and the nonaqueous binder may be used in combination. The aqueous binder means a binder that can be dissolved or dispersed in an aqueous solvent when a composite is prepared. The aqueous solvent means water or a mixed solvent mainly containing water. Examples of the solvent other than water constituting the mixed solvent include organic solvents (lower alcohols and lower ketones and the like) that can be uniformly mixed with water. The nonaqueous binder means a binder that can be dissolved or dispersed in a nonaqueous solvent when a composite is prepared. Examples of the nonaqueous solvent include N-methyl-2-pyrrolidone (NMP). As the binder, known binders can be used, and for example, fluorine resins (polytetrafluoroethylene (PTFE), tetrafluoroethylene-perfluoroalkyl vinyl ether copolymer (PFA), tetrafluoroethylene-hexafluoropropylene copolymer (FEP), and ethylene-tetrafluoroethylene copolymer (ETFE) and the like), vinyl acetate copolymer, styrene butadiene rubber (SBR), acrylic acid-modified SBR, ethylene-propylene-diene rubber (EPDM), sulfonated EPDM, fluorine rubber, gum arabic, polyvinylidene fluoride (PVDF), polyvinylidene chloride (PVDC), polyethylene, polypropylene, polyethylene oxide (PEO), polypropylene oxide (PPO), and polyethylene oxide-propylene oxide copolymer (PEO-PPO) and the like can be used. Among these, from the viewpoint of binding properties and resistance increase suppressing properties, rubber-based binders such as SBR, acrylic acid-modified SBR, EPDM, sulfonated EPDM, fluororubber, and gum arabic are preferable, and SBR is more preferable. When the binder has a functional group that is reactive with lithium or the like, the functional group may be deactivated by methylation or the like in advance. The lower limit of the content of the binder in the negative active material layer is preferably 1% by mass, and more preferably 2% by mass. Meanwhile, the upper limit of the content of the binder is preferably 10% by mass, and more preferably 5% by mass. By setting the content of the binder within the above range, the input performance and the like of the nonaqueous electrolyte energy storage device at a low temperature can be further enhanced.

The content of the binder in the negative active material layer 23 is preferably 1% by mass or more and 10% by mass or less, and more preferably 3% by mass or more and 9% by mass or less. When the content of the binder is within the above-described range, the negative active material particles can be stably held.

Examples of the thickener include polysaccharide polymers such as carboxymethylcellulose (CMC) and methylcellulose. When the thickener has a functional group that is reactive with lithium and the like, the functional group may be deactivated by methylation or the like in advance.

The negative active material layer preferably contains a cellulose derivative in which a counter cation is a metal ion. The cellulose derivative is a component that functions as a thickener when the negative active material layer is formed by coating or the like. The cellulose derivative is a compound having a structure in which a hydrogen atom of a hydroxy group of cellulose is substituted with another group. Examples of the cellulose derivative having a counter cation include carboxyalkyl celluloses (carboxymethyl cellulose (CMC), carboxyethyl cellulose, and carboxypropyl cellulose and the like), alkyl celluloses (methyl cellulose and ethyl cellulose and the like), hydroxyalkyl celluloses (hydroxyethyl cellulose, hydroxypropyl cellulose, hydroxyethyl methyl cellulose, and hydroxypropyl methyl cellulose and the like), cellulose acetate phthalate, hydroxypropyl methyl cellulose phthalate, and acetyl cellulose. Among these, carboxyalkyl cellulose is preferable, and CMC is more preferable. The cellulose derivatives may be used singly or in combination of two or more kinds thereof. Examples of the metal ion to be the counter cation include a sodium ion, a magnesium ion, and a lithium ion.

The content of the cellulose derivative in the negative active material layer is not particularly limited, but the lower limit thereof is 0.1% by mass. The lower limit of the content of the cellulose derivative is preferably 0.3% by mass, and more preferably 0.5% by mass. Meanwhile, the upper limit of the content of the cellulose derivative is, for example, 10% by mass. The upper limit of the content of the cellulose derivative is preferably 5% by mass, and more preferably 3% by mass. In some aspects, the upper limit of the content of the cellulose derivative may be 2% by mass or 1.5% by mass (for example, 1.2% by mass). By setting the content of the cellulose derivative to be equal to or greater than the above lower limit, a sufficient viscosity can be imparted to the negative composite paste when the negative active material layer is formed, whereby the negative active material layer can be efficiently formed. Meanwhile, by setting the content of the cellulose derivative to be equal to or less than the above upper limit, the above-described performance improvement effect (for example, the effect of suppressing an increase in resistance after a charge-discharge cycle) can be more effectively exhibited.

The filler is not particularly limited. Examples of the main component of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals such as calcium fluoride, barium fluoride, and barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. When a filler is used in the negative active material layer 23, the ratio of the filler in the entire negative active material layer can be about 8.0% by mass or less, and is usually preferably about 5.0% by mass or less (for example, 1.0% by mass or less).

### (Intermediate Layer)

The intermediate layer is a coating layer on the surface of the negative electrode substrate 22, and contains conductive particles such as carbon particles to reduce contact resistance between the negative electrode substrate 22 and the negative active material layer 23. The configuration of the intermediate layer is not particularly limited, and the intermediate layer can be formed of, for example, a composition containing a resin binder and conductive particles.

In the energy storage device 1, when the true density of the non-graphitizable carbon is A [g/cm³], the amount of charge B [mAh/g] of the negative electrode 12 in a fully charged state satisfies the following formula 1.

$$\text{-} 730 \times \text{A} + 1588 \leq \text{B} \leq \text{-} 830 \times \text{A} + 1800$$

In the energy storage device 1, when the true density of the non-graphitizable carbon is A [g/cm³], the amount of charge B [mAh/g] of the negative electrode 12 in the fully charged state is -830 × A + 1800 or less, so that the amount of charge B has an appropriate size, which makes it possible to suppress the occurrence of excessive deposition of metallic lithium. When the amount of charge B of the negative electrode 12 is in the range of -730 × A+ 1588 or more, at least one end edge side of the negative active material layer 23 is thicker than the central portion present between the one end edge side and the other end edge side, so that the occlusion amount of lithium ions per unit area on the end edge side of the negative active material layer 23 in which the amount of lithium ions that needs to be occluded locally increases can be reduced. In the energy storage device 1, the amount of charge B of the negative electrode in the fully charged state falls within a specific range satisfying the above formula 1, whereby the deposition of metallic lithium can be suppressed even when the amount of charge B is relatively large, and as a result, the durability of the energy storage device can be improved.

In the energy storage device, when the true density of the non-graphitizable carbon is A [g/cm³], the amount of charge B [mAh/g] of the negative electrode in a fully charged state may satisfy the following formula 2.

$$\text{-} 660 \times \text{A} + 1433 \leq \text{B} \leq \text{-} 830 \times \text{A} + 1800$$

In the energy storage device, when the true density of the non-graphitizable carbon is A [g/cm³], the amount of charge B [mAh/g] of the negative electrode in the fully charged state is -830 × A + 1800 or less, so that the amount of charge B has an appropriate size, which makes it possible to suppress the occurrence of excessive deposition of metallic lithium. When the amount of charge B of the negative electrode is in the range of -660 × A+ 1433 or more, the porosity of the separator is 50% or more, so that the migration resistance of the lithium ions in the separator can be reduced, and therefore the potential of the negative electrode can be made relatively noble. Therefore, the deposition of the metallic lithium can be suppressed, which accordingly makes it possible to suppress the decrease in the capacity retention ratio after the charge-discharge cycle.

In the energy storage device, when the true density of the non-graphitizable carbon is A [g/cm³], the amount of charge B [mAh/g] of the negative electrode in a fully charged state may satisfy the following formula 3.

$$\text{-} 580 \times \text{A} + 1258 \leq \text{B} \leq \text{-} 830 \times \text{A} + 1800$$

In the energy storage device, when the true density of the non-graphitizable carbon is A [g/cm³], the amount of charge B [mAh/g] of the negative electrode in the fully charged state is -830 × A + 1800 or less, so that the amount of charge B has an appropriate size, which makes it possible to suppress the occurrence of excessive deposition of metallic lithium. When the amount of charge B of the negative electrode is in the range of -580 × A+ 1258 or more, an increase in resistance after a charge-discharge cycle can be suppressed by using, as a binder of the negative active material layer, a cellulose derivative in which a counter cation that is excellent in reduction resistance and is considered to be less likely to be reductively decomposed even in a state where a negative electrode potential is low is a metal ion. Therefore, the energy storage device is excellent in an effect of suppressing an increase in resistance after a charge-discharge cycle when the non-graphitizable carbon is used as the active material of the negative electrode having a large depth of charge.

The amount of charge B of the negative electrode 12 is measured by the following procedure.
(1) A target battery is discharged to the end of discharge (low SOC region) in a glove box.
(2) In the glove box controlled to an atmosphere having an oxygen concentration of 5 ppm or less, the battery is disassembled, and a positive electrode plate and a negative electrode plate are taken out to assemble a small-sized laminate cell.
(3) After the small-sized laminate cell is charged with electricity to the fully charged state, constant current constant voltage (CCCV) discharge is performed up to 0.01 CA at the lower limit voltage at which the rated capacity is obtained by the energy storage device.
(4) In the glove box controlled to an atmosphere having an oxygen concentration of 5 ppm or less, the small-sized laminate cell is disassembled. The negative electrode is taken out, and a small-sized laminate cell in which lithium metal is disposed as a counter electrode is reassembled.
(5) Additional discharge is performed at a current density of 0.01 CA until the negative electrode potential reaches 2.0 V (vs. Li/Li⁺) to adjust the negative electrode to a fully discharged state.
(6) The total amount of electricity in the above (3) and (5) is divided by the mass of the negative electrode of a positive-negative electrode facing portion in the small-sized laminate cell to obtain an amount of charge.

### Positive Electrode

As described above, the positive electrode 11 includes the rectangular positive electrode substrate 21 and the positive active material layer 24.

### Positive Electrode Substrate

The positive electrode substrate 21 is a substrate having conductivity. As the material of the positive electrode substrate, a metal such as aluminum, titanium, tantalum or stainless steel, or an alloy thereof is used. Among these, aluminum and aluminum alloys are preferable from the viewpoint of the balance among electric potential resistance, high conductivity, and cost. Examples of the form of the positive electrode substrate 21 include a foil and a vapor deposited film, and a foil is preferable from the viewpoint of cost. In other words, an aluminum foil is preferable as the positive electrode substrate 21. Examples of the aluminum or aluminum alloy include A1085 and A3003 prescribed in JIS-H4000 (2014).

### Positive Active Material Layer

The positive active material layer 24 is formed of a so-called positive composite containing a positive active material. The positive active material can be appropriately selected from, for example, known positive active materials. As the positive active material for a lithium ion nonaqueous electrolyte secondary battery, a material capable of storing and releasing lithium ions is usually used. Examples of the positive active material include lithium-transition metal composite oxides having an α—NaFeO₂—type crystal structure, lithium-transition metal oxides having a spinel-type crystal structure, polyanion compounds, chalcogenides, and sulfur. Examples of the lithium transition metal composite oxide having an α—NaFeO₂ type crystal structure include Li[LiₓNi₁₋ₓ]O₂ (0 < x < 0.5), Li[LiₓNi_{Y}Co_{(1-x-Y)}]O₂ (0 ≤ x < 0.5, 0 < y < 1), Li[LiₓCo₍₁₋ₓ₎]O₂ (0 ≤ x < 0.5), Li[LiₓNi_{y}Mn_{(1-x-y)}]O₂ (0 ≤ x < 0.5, 0 < y < 1), Li[LiₓNi_{y}Mn_{β}Co_{(1-x-y-β)}]O₂ (0 ≤ x < 0.5, 0 < y, 0 < β, 0.5 < y + β < 1), and Li[LiₓNi_{y}Co_{β}Al_{(1-x-y-β)}]O₂ (0 ≤ x < 0.5, 0 < y, 0 < β, 0.5 < y + β < 1). Examples of the lithium-transition metal composite oxides having a spinel-type crystal structure include LiₓMn₂O₄ and LiₓNi_{y}Mn_{(2-y)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. Apart of atoms or polyanions in these materials may be substituted with atoms or anion species composed of other elements. The surfaces of these materials may be coated with other materials.

The positive active material is preferably a nickel-containing lithium transition metal composite oxide containing nickel. The molar ratio of nickel to the total of the metal elements excluding lithium in the nickel-containing lithium transition metal composite oxide is preferably 0.5 or more (for example, 0.5 or more and 1 or less), and more preferably 0.55 or more (for example, 0.6 or more and 0.9 or less). Particularly preferable examples of the positive active material include a positive active material containing a lithium transition metal composite oxide containing nickel, cobalt, and manganese as a main component, in which the molar ratio of nickel to the total of nickel, cobalt, and manganese in the lithium transition metal composite oxide is 0.5 or more (for example, 0.5 or more and 0.9 or less, typically 0.6 or more and 0.8 or less). By setting the molar ratio of nickel to the total of nickel, cobalt, and manganese in the lithium transition metal composite oxide within the above range, the capacity retention ratio of the energy storage device 1 after a charge-discharge cycle can be increased.

In the positive active material layer 24, one of these materials may be used singly or two or more thereof may be used in mixture. In the positive active material layer 24, one of these compounds may be used singly, or two or more thereof may be used in mixture.

The content of the positive active material in the positive active material layer is not particularly limited, but the lower limit thereof is preferably 50% by mass, more preferably 80% by mass, and still more preferably 90% by mass. Meanwhile, the upper limit of this content is preferably 99% by mass, and more preferably 98% by mass.

The amount of charge B of the negative electrode in the fully charged state can be adjusted, for example, by changing a ratio N/P of a mass N of the negative active material per unit area in the negative active material layer to a mass P of the positive active material per unit area in the positive active material layer. In one aspect, when the true density of the non-graphitizable carbon is A [g/cm³], a ratio N/P of a mass N of the negative active material per unit area in the negative active material layer to a mass P of the positive active material per unit area in the positive active material layer preferably satisfies the following formula 4.

$$0.57 \times \text{A} \text{-} 0.53 \leq \text{N/P} \leq 0.45$$

When N/P satisfying the above formula 4 is applied to a conventional battery using non-graphitizable carbon, the depth of charge is greater than a normal depth of charge, whereby the deposition of metallic lithium is apt to occur. However, in the energy storage device, at least one end edge side of the negative active material layer is thicker than a central portion present between the one end edge side and the other end edge side, which makes it possible to reduce the occlusion amount of lithium ions per unit area on the end edge side of the negative active material layer in which the amount of lithium ions required to be occluded locally increases. Therefore, even when the depth of charge is in a relatively large range, the deposition of metallic lithium can be suppressed, so that the durability of the energy storage device can be improved.

In one aspect, when the true density of the non-graphitizable carbon is A [g/cm³], a ratio N/P of a mass N of the negative active material per unit area in the negative active material layer to a mass P of the positive active material per unit area in the positive active material layer preferably satisfies the following formula 5.

$$0.57 \times \text{A -} 0.53 \leq \text{N/P} \leq 0.70 \times \text{A -} 0.65$$

When N/P satisfying the above formula 5 is applied to a conventional battery using non-graphitizable carbon, the depth of charge is greater than a normal depth of charge, whereby the deposition of metallic lithium is apt to occur. However, in the energy storage device, when the porosity of the separator is 50% or more, the migration resistance of the lithium ions in the separator can be reduced, and therefore the potential of the negative electrode can be made relatively noble. Therefore, the deposition of the metallic lithium can be suppressed, which accordingly makes it possible to suppress the decrease in the capacity retention ratio after the charge-discharge cycle.

In one aspect, when the true density of the non-graphitizable carbon is A [g/cm³], a ratio N/P of a mass N of the negative active material per unit area in the negative active material layer to a mass P of the positive active material per unit area in the positive active material layer preferably satisfies the following formula 6.

$$0.57 \times \text{A - 0} \text{.53} \leq \text{N/P} \leq \text{0} \text{.83} \times \text{A - 0} \text{.77}$$

When N/P satisfying the above formula 6 is applied to a conventional battery using non-graphitizable carbon, the depth of charge is greater than a normal depth of charge, whereby the negative electrode potential becomes low, which may cause an increase in resistance after a charge-discharge cycle due to the deposition of metallic lithium during charge. However, when the energy storage device uses, as a binder of the negative active material layer, a cellulose derivative which is excellent in reduction resistance and in which a counter cation which is considered to be less likely to be reductively decomposed even in a state where a negative electrode potential is low is a metal ion in a range of N/P satisfying the above formula 6, the energy storage device can exhibit an effect of suppressing an increase in resistance after a charge-discharge cycle.

### Other Optional Components

The positive composite contains optional components such as a conductive agent, a binder, a thickener, and a filler and the like as necessary. The optional components such as a conductive agent, a binder, a thickener, and a filler can be selected from the materials exemplified for the negative electrode.

The conductive agent is not particularly limited so long as being a conductive material. Such a conductive agent can be selected from the materials exemplified for the negative electrode. When a conductive agent is used, the ratio of the conductive agent to the entire positive active material layer can be about 1.0% by mass to 20% by mass, and is preferably usually about 2.0% by mass to 15% by mass (for example, 3.0% by mass to 6.0% by mass).

The binder can be selected from the materials exemplified for the negative electrode. When a binder is used, the ratio of the binder to the entire positive active material layer can be about 0.50% by mass to 15% by mass, and is preferably usually about 1.0% by mass to 10% by mass (for example, 1.5% by mass to 3.0% by mass).

Examples of the thickener include polysaccharide polymers such as carboxymethylcellulose (CMC) and methylcellulose. When the thickener has a functional group that is reactive with lithium, it is preferable to deactivate this functional group by methylation and the like in advance. When a thickener is used, the ratio of the thickener to the entire positive active material layer can be about 8% by mass or less, and is preferably usually about 5.0% by mass or less (for example, 1.0% by mass or less).

The filler can be selected from the materials exemplified for the negative electrode. When a filler is used, the ratio of the filler to the entire positive active material layer can be about 8.0% by mass or less, and is preferably usually about 5.0% by mass or less (for example, 1.0% by mass or less).

### Intermediate Layer

The intermediate layer is a covering layer on the surface of the positive electrode substrate 21, and reduces contact resistance between the positive electrode substrate 21 and the positive active material layer 24 by including conductive particles such as carbon particles. Similarly to the negative electrode, the configuration of the intermediate layer is not particularly limited and can be formed of, for example, a composition containing a resin binder and conductive particles.

### Nonaqueous Electrolyte

As the nonaqueous electrolyte, a known nonaqueous electrolyte normally used for a general nonaqueous electrolyte secondary battery (energy storage device) can be used. The nonaqueous electrolyte contains a nonaqueous solvent and an electrolyte salt dissolved in the nonaqueous solvent. The nonaqueous electrolyte may be a solid electrolyte or the like.

As the nonaqueous solvent, it is possible to use a known nonaqueous solvent usually used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable use the cyclic carbonate and the chain carbonate in combination. When the cyclic carbonate and the chain carbonate are used in combination, the volume ratio of the cyclic carbonate to the chain carbonate (cyclic carbonate : chain carbonate) is not particularly limited, but is preferably from 5 : 95 to 50 : 50, for example.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate, and 1,2-diphenylvinylene carbonate, and among these, EC is preferable.

Examples of the chain carbonate include diethyl carbonate (DEC), dimethyl carbonate (DMC), ethyl methyl carbonate (EMC), and diphenyl carbonate, and among these, EMC is preferable.

As the electrolyte salt, it is possible to use a known electrolyte salt usually used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts having a hydrocarbon group in which hydrogen is replaced by fluorine, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The lower limit of the concentration of the electrolyte salt in the nonaqueous electrolyte is preferably 0.1 mol/dm³, more preferably 0.3 mol/dm³, still more preferably 0.5 mol/dm³, and particularly preferably 0.7 mol/dm³. Meanwhile, the upper limit is not particularly limited, and is preferably 2.5 mol/dm³, more preferably 2.0 mol/dm³, and still more preferably 1.5 mol/dm³.

Other additives may be added to the nonaqueous electrolyte. As the nonaqueous electrolyte, a salt that is melted at normal temperature, or an ionic liquid or the like can also be used.

### Separator

The separator 25 is interposed between the negative electrode and the positive electrode. As the separator, for example, a woven fabric, a nonwoven fabric, and a porous resin film and the like are used. Among these, a porous resin film is preferable from the viewpoint of strength, and a nonwoven fabric is preferable from the viewpoint of liquid retaining property of the nonaqueous electrolyte. Examples of the main component of the separator include polyolefins such as polyethylene and polypropylene, polyesters such as polyethylene terephthalate and polybutylene terephthalate, polyacrylonitrile, polyphenylene sulfide, polyimide, and fluororesin from the viewpoint of strength. Among these, polyolefins such as polyethylene and polypropylene are preferable. These resins may be composited.

The lower limit of the porosity of the separator is preferably 50%. In some aspects, the porosity of the separator may be 52% or more, 55% or more, or 58% or more (for example, 60% or more). The upper limit of the porosity of the separator is preferably 70%, and more preferably 65%. By setting the porosity within the above range, the effect of suppressing the decrease in the capacity retention ratio in the charge-discharge cycle can be further enhanced. The porosity is a ratio of a void volume to the total volume of the porous resin layer, and is measured in accordance with “Pore Volume Rate” specified in JIS-L1096 (2010).

The average thickness of the separator is not particularly limited, but the lower limit thereof is preferably 3 µm, more preferably 5 µm, and still more preferably 7 µm. In some aspects, the average thickness of the separator may be, for example, 8 µm or more, and typically 10 m or more. Meanwhile, the upper limit of the average thickness of the separator is preferably 30 µm, and more preferably 25 µm. In some aspects, the average thickness of the separator may be, for example, 20 µm or less, and typically 15 µm or less. The technique disclosed herein can be preferably implemented, for example, in an aspect in which the average thickness of the separator is 3 µm or more and 30 µm or less (further, 8 µm or more and 15 µm or less).

Note that an inorganic layer may be layered between the separator and the electrode (for example, the positive electrode). This inorganic layer is a porous layer, which is also called a heat resistant layer and the like. A separator having an inorganic layer formed on one surface or both surfaces of the porous resin film can also be used. The inorganic layer is usually composed of inorganic particles and a binder, and may contain other components. The technique disclosed herein may be implemented in an aspect in which the inorganic layer is not layered between the separator and the negative electrode.

The inorganic particles contained in the inorganic layer preferably have a mass loss of 5% or less at 500° C. in the atmosphere, and more preferably have a mass loss of 5% or less at 800° C. in the atmosphere. Examples of materials having a mass loss of a predetermined value or less include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide, and aluminosilicate; hydroxides such as magnesium hydroxide, calcium hydroxide, and aluminum hydroxide; nitrides such as aluminum nitride and silicon nitride; carbonates such as calcium carbonate; sulfates such as barium sulfate; hardly soluble ionic crystals such as calcium fluoride, barium fluoride, and barium titanate; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more kinds thereof may be used in mixture. Among these inorganic compounds, silicon oxide, aluminum oxide, or aluminosilicate is preferable.

### Method for Producing Energy Storage Device

The method for producing the energy storage device includes preparing a negative electrode, preparing a positive electrode, preparing a nonaqueous electrolyte, layering or winding the positive electrode and the negative electrode with a separator interposed between the electrodes to form an electrode assembly, housing the electrode assembly in a case, and injecting the nonaqueous electrolyte into the case. The positive electrode can be obtained by directly layering the positive active material layer on a positive electrode substrate or layering the positive active material layer on the positive electrode substrate with an intermediate layer interposed therebetween. The positive active material layer is layered by applying a positive active material paste to the positive electrode substrate. The negative electrode can be obtained by directly layering the negative active material layer on a negative electrode substrate or layering the negative active material layer on the negative electrode substrate with an intermediate layer interposed therebetween as with the positive electrode. The negative active material layer is layered by applying a negative composite paste containing non-graphitizable carbon to the negative electrode substrate. The positive composite paste and the negative composite paste may contain a dispersion medium. As the dispersion medium, it is possible to use, for example, an aqueous solvent such as water or a mixed solvent mainly composed of water or an organic solvent such as N-methylpyrrolidone or toluene.

A method for housing the negative electrode, the positive electrode, and the nonaqueous electrolyte and the like into the case can be performed in accordance with a known method. After the housing, by sealing an opening for the housing, an energy storage device can be obtained. The details of the respective elements configuring the energy storage device obtained by the producing method are as described above.

When non-graphitizable carbon is used for an active material of a negative electrode having a large depth of charge, the deposition of metallic lithium can be suppressed to improve the durability of the energy storage device. By suppressing the deposition of the metallic lithium, the safety of the energy storage device can also be improved. Furthermore, in one direction of the negative electrode substrate, at least one end edge side of the negative active material layer is thicker than a central portion present between the one end edge side and the other end edge side, which makes it possible to suppress the positive electrode from being shifted in the end edge direction when vibration in the vertical direction is applied to the battery case.

### Other Embodiments

The energy storage device of the present invention is not limited to the embodiments described above, and various changes may be made without departing from the scope of the present invention. For example, to the configuration of an embodiment, the configuration of another embodiment can be added, and a part of the configuration of an embodiment can be replaced by the configuration of another embodiment or a well-known technique. Furthermore, a part of the configuration according to one embodiment can be removed. In addition, a well-known technique can be added to the configuration according to one embodiment.

In the above embodiment, the energy storage device has been described mainly in the form of a nonaqueous electrolyte secondary battery, but the nonaqueous electrolyte energy storage device may be other energy storage devices. Examples of the other energy storage devices include capacitors (electric double-layer capacitors and lithium ion capacitors). Examples of the nonaqueous electrolyte secondary battery include a lithium ion nonaqueous electrolyte secondary battery.

Although the wound electrode assembly has been used in the above embodiment, a layered electrode assembly may be provided, which is formed of a layered product where a plurality of sheet bodies having a positive electrode, a negative electrode, and a separator are layered.

The shape of the energy storage device of the present embodiment is not particularly limited, and examples thereof include cylindrical batteries, layered film batteries, flat batteries, coin batteries, and button batteries in addition to the prismatic batteries.

The present invention can also be realized as an energy storage apparatus including the plurality of energy storage devices. In this case, the technique of the present invention may be applied to at least one energy storage device included in the energy storage apparatus. An assembled battery can be constituted using one or a plurality of energy storage devices (cells) of the present invention, and an energy storage apparatus can be constituted using the assembled battery. The energy storage apparatus can be used as a power source for an automobile, such as an electric vehicle (EV), a hybrid vehicle (HEV), or a plug-in hybrid vehicle (PHEV). The energy storage apparatus can be used for various power source apparatuses such as engine starting power source apparatuses, auxiliary power source apparatuses, and uninterruptible power systems (UPSs).

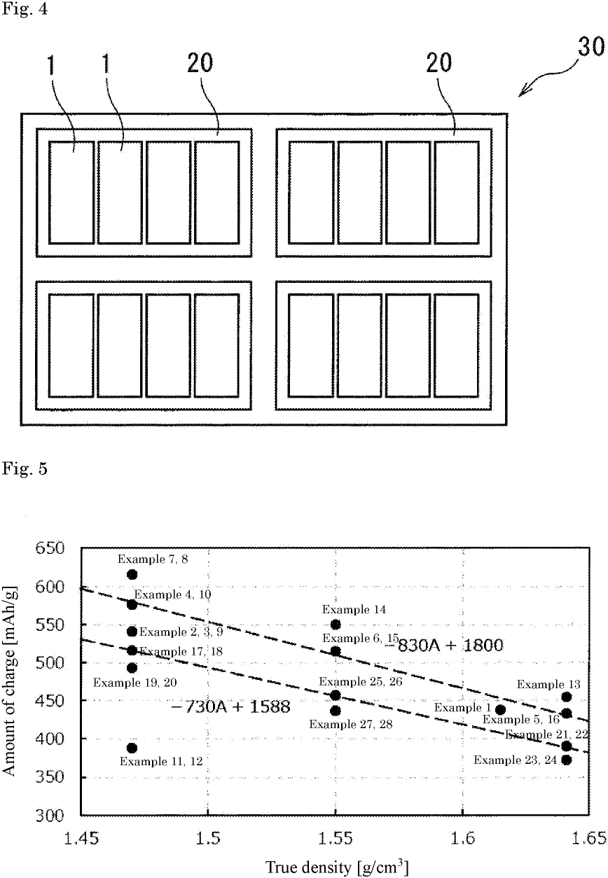

FIG. 4 shows an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1 and a busbar (not illustrated) for electrically connecting two or more energy storage units 20. The energy storage unit 20 or the energy storage apparatus 30 may include a state monitor (not illustrated) for monitoring the state of one or more energy storage devices.

### EXAMPLES

Hereinafter, the present invention will be described in more detail with reference to Examples, but the present invention is not limited to the following Examples.

### Examples 1 to 28

### Preparation of Negative Electrode

Non-graphitizable carbon as a negative active material, a styrene-butadiene rubber (SBR) as a binder, carboxymethyl cellulose (CMC) as a thickener, and water as a dispersion medium were mixed to prepare a negative composite paste. The mass ratio of the non-graphitizable carbon to the styrene-butadiene rubber (carboxymethyl cellulose (CMC)) was set to 97.4 : 2.0 : 0.6 in terms of solid content.

The negative composite paste was prepared by adjusting the amount of water to adjust the viscosity and mixing using a multi-blender mill. The negative composite paste was applied to both surfaces of a copper foil as a negative electrode substrate such that a non-layered portion was formed at one end edge of the copper foil. Next, a negative active material layer was produced by drying. After the drying, the negative active material layer was roll-pressed so as to have a predetermined packing density, thereby obtaining a negative electrode.

### Preparation of Positive Electrode

Lithium nickel cobalt manganese composite oxide as a positive active material, acetylene black (AB) as a conductive agent, polyvinylidene fluoride (PVDF) as a binder, and N-methylpyrrolidone (NMP) as a nonaqueous dispersion medium were used to prepare a positive composite paste (positive active material layer-forming material). The mass ratio of the positive active material, the binder, and the conductive agent was set to 94.5 : 4.0 : 1.5 in terms of solid content. The positive composite paste was applied to both surfaces of an aluminum foil as a positive electrode substrate such that a non-layered portion was formed at one end edge of the aluminum foil. Next, a positive active material layer was prepared by drying. After the drying, the positive active material layer was roll-pressed so as to have a predetermined packing density, thereby obtaining a positive electrode. The N/P ratios of Examples 1 to 28 are shown in Table 1. Here, the molar ratio of nickel, cobalt, and manganese (Ni : Co : Mn ratio) of the lithium nickel cobalt manganese composite oxide as the positive active material was set to 6.0 : 2.0 : 2.0.

### Nonaqueous Electrolyte

A nonaqueous electrolyte was prepared by dissolving LiPF₆ in a solvent in which propylene carbonate (PC) and diethyl carbonate (DEC) were mixed at a volume ratio of 30 : 70 so that a salt concentration was 1.2 mol/dm³.

### Separator

As a separator, a polyethylene microporous film having a thickness of 14 µm was used.

### Energy Storage Device

The positive electrode, the negative electrode, and the separator were layered to prepare an electrode assembly. Thereafter, the non-layered portion of the positive electrode substrate and the non-layered portion of the negative electrode substrate were respectively welded to a positive current collector and a negative current collector, and enclosed in a case. Next, the case was welded to a lid plate. Then, the nonaqueous electrolyte was injected into the case, and a case opening was sealed. In this way, batteries (energy storage devices) of Examples 1 to 28 were obtained. The designed rated capacity of the battery is 40.9 Ah.

### Evaluation

### True Density of Non-Graphitizable Carbon

The true density of the non-graphitizable carbon was measured by the following procedure.

The non-graphitized carbon in a discharged state was immersed in water to remove the binder and the thickener, and then vacuum-dried at 25° C. for 12 hours. Then, the non-graphitized carbon was taken out. Next, the non-graphitized carbon was dried at 120° C. for 2 hours, and cooled to room temperature in a desiccator. The mass (m1) of a pycnometer was accurately measured. About 3 g of the non-graphitized carbon was put in the pycnometer, and the mass thereof was accurately measured (m2). Next, 1-butanol was gently added to the pycnometer until it reached a depth of about 20 mm from the bottom. The pycnometer was placed in a vacuum desiccator, and gradually evacuated to maintain the pressure at 2.0 kPa to 2.6 kPa. This pressure was maintained for 20 minutes, and after the generation of bubbles was stopped, the pycnometer was taken out from the vacuum desiccator, and 1-butanol was further added into the pycnometer. The pycnometer was immersed in a constant temperature water bath at 30±0.5° C. for 30 minutes, and the liquid level of 1-butanol was aligned with a marked line. The pycnometer was taken out. The outside of the pycnometer was thoroughly wiped, and the mass thereof was accurately measured. The pycnometer was immersed again in the constant temperature water bath for 15 minutes, and the 1-butanol liquid level was aligned with the marked line. The pycnometer was taken out. The outside of the pycnometer was thoroughly wiped, and the mass thereof was accurately measured. This step is repeated three times, and the average value of the masses when the step is repeated three times is defined as (m4). Next, a step of filling the same pycnometer with 1-butanol, immersing the pycnometer in the constant temperature water bath similarly as described above, and measuring the mass after aligning the liquid level of 1-butanol with the marked line is repeated four times, and the average value of the masses when the step is repeated four times is taken as (m3). A step of putting deaerated water immediately before use in the same pycnometer, immersing the pycnometer in the constant temperature water bath similarly as described above, and measuring the mass after aligning the liquid level of water with the marked line is repeated four times, and the average value thereof is taken as (m5). A true density A was calculated by the following formula 7. In the following formula 7, d is the specific gravity of water at 30° C., and d = 0.9946 is set.

$$\text{A} = \left(\text{m2} \text{-} \text{m1}\right) \text{/} \left(\text{m2} \text{-} \text{m1} \text{-} \left(\text{m4-m3}\right)\right) \times \left(\left(\text{m3} \text{-} \text{m1}\right) \text{/} \left(\text{m5} \text{-} \text{m1}\right)\right) \times \text{d}$$

### Amount of Charge of Negative Electrode

The amount of charge of the negative electrode was measured by the above-described method.

### Capacity Retention Ratio After Charge-Discharge Cycle

### Initial Discharge Capacity Confirmation Test

Each energy storage device was subjected to constant current constant voltage (CCCV) charge until the charge current reached 0.4 A or less under the conditions of a charge current of 13.6 A and an end-of-charge voltage of 4.32 V in a thermostatic bath at 25° C., followed by a rest period of 20 minutes. Thereafter, constant current (CC) discharge was performed at a discharge current of 40.9 A and an end-of-discharge voltage of 2.4 V. A discharge capacity at this time was defined as “initial discharge capacity”.

### Capacity Retention Ratio

Each energy storage device after the measurement of the “initial discharge capacity” was subjected to constant current constant voltage (CCCV) charge until the charge current reached 0.4 A or less under the conditions of a charge current of 13.6 A and an end-of-charge voltage of 4.32 V in a thermostatic bath at 45° C., followed by a rest period of 10 minutes. Subsequently, constant current (CC) discharge was performed at a discharge current of 40.9 A to an end-of-discharge voltage of 2.4 V, followed by a rest period of 10 minutes. This charge-discharge cycle was performed for 500 cycles. After 500 cycles, a discharge capacity was measured under the same conditions as those in the measurement test of the “initial discharge capacity”, and the discharge capacity at this time was defined as “capacity after 500 cycles”. The “capacity after 500 cycles” with respect to the “initial discharge capacity” was defined as a capacity retention ratio after the charge-discharge cycle.

### Evaluation of Deposition of Metallic Lithium

The evaluation of deposition of metallic lithium was performed by the following procedure.

The battery after the initial capacity confirmation was disassembled in a discharged state. The negative electrode was washed with dimethyl carbonate (DMC), and the surface of the negative electrode was then visually observed. When the negative electrode was washed with dimethyl carbonate (DMC), and a white deposit was then present on the surface of the negative electrode, metallic lithium was determined to be deposited.

### Measurement of Thicknesses of End Edge on Non-Layered Portion side and Central Portion of Negative Active Material Layer

The thicknesses of the end edge on the non-layered portion side and the central portion of the negative active material layer were measured by the above procedure.

The following Table 1 shows the amount of charge of the negative electrode, the N/P ratio of the central portion of the negative active material layer, the capacity retention ratio and the evaluation of the capacity retention ratio after the charge-discharge cycle, the evaluation of deposition of metallic lithium, and the evaluation results of the thickness difference between the end edge on the non-layered portion side and the central portion of the negative active material layer in Test Examples. FIG. 5 shows the relationship between the true density of the non-graphitizable carbon in the negative active material and the amount of charge of the negative electrode in a fully charged state in the Test Examples.

Table 1

| | True density [g/cm³] | Upper limit of amount of charge y = -830A+1800 [mAh/g] | Amount of charge [mAh/g] | Lower limit of amount of charge y = -730A+1588 [mAh/g] | N/P ratio of central portion | Thickness of end edge [µm] | Thickness of central portion [µm] | Thickness in difference between end edge and central portion [µm] | Capacity retention ratio after 500 cycles [%] | Amount of charge Equal to or less than y = -830A+1800 Equal to or greater than y = -730A+1588 Determination | Evaluation of deposition of metallic lithium |
|---|---|---|---|---|---|---|---|---|---|---|---|
| Example 1 | 1.615 | 460 | 438 | 409 | 0.41 | 130 | 127 | 3 | 88 | Applicable | No deposition |
| Example 2 | 1.470 | 580 | 541 | 515 | 0.33 | 134 | 130 | 4 | 88 | Applicable | No deposition |
| Example 3 | 1.470 | 580 | 541 | 515 | 0.33 | 131 | 130 | 1 | 87 | Applicable | No deposition |
| Example 4 | 1.470 | 580 | 576 | 515 | 0.31 | 128 | 124 | 4 | 88 | Applicable | No deposition |
| Example 5 | 1.641 | 438 | 433 | 390 | 0.41 | 140 | 137 | 3 | 87 | Applicable | No deposition |
| Example 6 | 1.550 | 514 | 514 | 457 | 0.35 | 143 | 139 | 4 | 87 | Applicable | No deposition |
| Example 7 | 1.470 | 580 | 616 | 515 | 0.29 | 116 | 115 | 1 | 75 | More than y = -830A+1800 | Deposition |
| Example 8 | 1.470 | 580 | 616 | 515 | 0.29 | 115 | 115 | 0 | 74 | More than y = -830A+1800 | Deposition |
| Example 9 | 1.470 | 580 | 541 | 515 | 0.33 | 120 | 130 | -10 | 77 | Applicable | Deposition |
| Example 10 | 1.470 | 580 | 576 | 515 | 0.31 | 120 | 124 | -4 | 74 | Applicable | Deposition |
| Example 11 | 1.470 | 580 | 388 | 515 | 0.46 | 144 | 140 | 4 | 86 | Less than y = -730A+1588 | No deposition |
| Example 12 | 1.470 | 580 | 388 | 515 | 0.46 | 138 | 140 | ^{_}2 | 87 | Less than y = -730A+1588 | No deposition |
| Example 13 | 1.641 | 438 | 455 | 390 | 0.39 | 133 | 131 | 2 | 78 | More than y = -830A+1800 | Deposition |
| Example 14 | 1.550 | 514 | 550 | 457 | 0.33 | 136 | 133 | 3 | 78 | More than y = -830A+1800 | Deposition |
| Example 15 | 1.550 | 514 | 514 | 457 | 0.35 | 135 | 139 | -4 | 78 | Applicable | Deposition |
| Example 16 | 1.641 | 438 | 433 | 390 | 0.41 | 133 | 137 | -4 | 78 | Applicable | Deposition |
| Example 17 | 1.470 | 580 | 516 | 515 | 0.34 | 130 | 133 | -3 | 81 | Applicable | Deposition |
| Example 18 | 1.470 | 580 | 516 | 515 | 0.34 | 136 | 133 | 3 | 88 | Applicable | No deposition |
| Example 19 | 1.470 | 580 | 493 | 515 | 0.36 | 135 | 138 | -3 | 87 | Less than y = -730A+1588 | No deposition |
| Example 20 | 1.470 | 580 | 493 | 515 | 0.36 | 141 | 138 | 3 | 86 | Less than y = -730A+1588 | No deposition |
| Example 21 | 1.641 | 438 | 390 | 390 | 0.45 | 144 | 147 | -3 | 80 | Applicable | Deposition |
| Example 22 | 1.641 | 438 | 390 | 390 | 0.45 | 150 | 147 | 3 | 87 | Applicable | No deposition |
| Example 23 | 1.641 | 438 | 372 | 390 | 0.46 | 148 | 151 | -3 | 86 | Less than y = -730A+1588 | No deposition |
| Example 24 | 1.641 | 438 | 372 | 390 | 0.46 | 154 | 151 | 3 | 85 | Less than y = -730A+1588 | No deposition |
| Example 25 | 1.550 | 514 | 457 | 457 | 0.39 | 146 | 149 | -3 | 81 | Applicable | Deposition |
| Example 26 | 1.550 | 514 | 457 | 457 | 0.39 | 152 | 149 | 3 | 87 | Applicable | No deposition |
| Example 27 | 1.550 | 514 | 436 | 457 | 0.41 | 150 | 153 | -3 | 86 | Less than y = -730A+1588 | No deposition |
| Example 28 | 1.550 | 514 | 436 | 457 | 0.41 | 156 | 153 | 3 | 85 | Less than y = -730A+1588 | No deposition |

As shown in Table 1 and FIG. 5, in Examples 1 to 6, 18, 22 and 26, when the true density of the non-graphitizable carbon was A [g/cm³], the amount of charge B [mAh/g] of the negative electrode in a fully charged state was in the range of -730 × A + 1588 ≤ B ≤ -830 × A + 1800, and one end edge side of the negative active material layer was thicker than a central portion present between the one end edge side and the other end edge side. In Examples 1 to 6, 18, 22 and 26, metallic lithium was not deposited, and the capacity retention ratio after the charge-discharge cycle was good.

Meanwhile, in Examples 9, 10, 15 to 17, 21, and 25 in which the amount of charge B [mAh/g] of the negative electrode was in the range of -730 × A + 1588 ≤ B ≤ -830 × A + 1800, but the central portion of the negative active material layer was thicker than the one end edge side, metallic lithium was deposited.

In Examples 11, 12, 19, 20, 23, 24, 27, and 28 in which the amount of charge B [mAh/g] of the negative electrode was less than -730 × A+ 1588, metallic lithium was not deposited regardless of the shape of the negative active material layer.

Furthermore, in Examples 7, 8, 13, and 14 in which the amount of charge B [mAh/g] of the negative electrode was more than -830 × A+ 1800, metallic lithium was deposited regardless of the shape of the negative active material layer.

In the energy storage device, when the amount of charge B [mAh/g] of the negative electrode in the fully charged state falls within a specific range satisfying -730 × A + 1588 ≤ B ≤ -830 × A + 1800, it is found that, by devising the shape of the end portion of the negative active material layer, the deposition of metallic lithium can be suppressed even when the amount of charge B is relatively large.

As a result, it was shown that the durability of the energy storage device can be improved when the non-graphitizable carbon is used for the active material of the negative electrode having a large depth of charge.

### Examples 29 to 54

### Preparation of Negative Electrode

Non-graphitizable carbon as a negative active material, a styrene-butadiene rubber (SBR) as a binder, carboxymethyl cellulose (CMC) as a thickener, and water as a dispersion medium were mixed to prepare a negative composite paste. The mass ratio of the non-graphitizable carbon to the styrene-butadiene rubber (carboxymethyl cellulose (CMC)) was set to 97.4 : 2.0 : 0.6 in terms of solid content.

The negative composite paste was prepared by adjusting the amount of water to adjust the viscosity and mixing using a multi-blender mill. The negative composite paste was applied to both surfaces of a copper foil as a negative electrode substrate such that a non-layered portion was formed at one end edge of the copper foil. Next, a negative active material layer was produced by drying. After the drying, the negative active material layer was roll-pressed so as to have a predetermined packing density, thereby obtaining a negative electrode.

### Preparation of Positive Electrode

Lithium nickel cobalt manganese composite oxide as a positive active material, acetylene black (AB) as a conductive agent, polyvinylidene fluoride (PVDF) as a binder, and N-methylpyrrolidone (NMP) as a nonaqueous dispersion medium were used to prepare a positive composite paste (positive active material layer-forming material). The mass ratio of the positive active material, the binder, and the conductive agent was set to 94.5 : 4.0 : 1.5 in terms of solid content. The positive composite paste was applied to both surfaces of an aluminum foil as a positive electrode substrate such that a non-layered portion was formed at one end edge of the aluminum foil. Next, a positive active material layer was prepared by drying. After the drying, the positive active material layer was roll-pressed so as to have a predetermined packing density, thereby obtaining a positive electrode. The N/P ratios of Examples 29 to 54 are shown in Table 2. Here, the molar ratio of nickel, cobalt, and manganese (Ni : Co : Mn ratio) of the lithium nickel cobalt manganese composite oxide as the positive active material was set to 6.0 : 2.0 : 2.0.

### Nonaqueous Electrolyte

A nonaqueous electrolyte was prepared by dissolving LiPF₆ in a solvent in which propylene carbonate (PC) and diethyl carbonate (DEC) were mixed at a volume ratio of 30 : 70 so that a salt concentration was 1.2 mol/dm³.

### Separator

As a separator, a polyethylene microporous film having a thickness of 14 µm was used.

### Energy Storage Device

The positive electrode, the negative electrode, and the separator were layered to prepare an electrode assembly. Thereafter, the non-layered portion of the positive electrode substrate and the non-layered portion of the negative electrode substrate were respectively welded to a positive current collector and a negative current collector, and enclosed in a case. Next, the case was welded to a lid plate. Then, the nonaqueous electrolyte was injected into the case, and a case opening was sealed. In this way, batteries (energy storage devices) of Examples 29 to 54 were obtained. The designed rated capacity of the battery is 40.9 Ah.

### Evaluation

### True Density of Non-Graphitized Carbon

The true density of the non-graphitizable carbon was measured by the above-described method.

### Amount of Charge of Negative Electrode

The amount of charge of the negative electrode was measured by the above-described method.

### Porosity of Separator

The porosity of the separator was measured in accordance with “Pore Volume Rate” specified in JIS-L1096 (2010).

### Capacity Retention Ratio After Charge-Discharge Cycle

### Initial Discharge Capacity Confirmation Test

Each energy storage device was subjected to constant current constant voltage (CCCV) charge until the charge current reached 0.4 A or less under the conditions of a charge current of 13.6 A and an end-of-charge voltage of 4.32 V in a thermostatic bath at 25° C., followed by a rest period of 20 minutes. Thereafter, constant current (CC) discharge was performed at a discharge current of 40.9 A and an end-of-discharge voltage of 2.4 V. A discharge capacity at this time was defined as “initial discharge capacity”.

### Capacity Retention Ratio

Each energy storage device after the measurement of the “initial discharge capacity” was subjected to constant current constant voltage (CCCV) charge until the charge current reached 0.4 A or less under the conditions of a charge current of 13.6 A and an end-of-charge voltage of 4.32 V in a thermostatic bath at 45° C., followed by a rest period of 10 minutes. Subsequently, constant current (CC) discharge was performed at a discharge current of 40.9 A to an end-of-discharge voltage of 2.4 V, followed by a rest period of 10 minutes. This charge-discharge cycle was performed for 1000 cycles. After 1000 cycles, a discharge capacity was measured under the same conditions as those in the measurement test of the “initial discharge capacity”, and the discharge capacity at this time was defined as “capacity after 1000 cycles”. The “capacity after 1000 cycles” with respect to the “initial discharge capacity” was defined as a capacity retention ratio after the charge-discharge cycle.

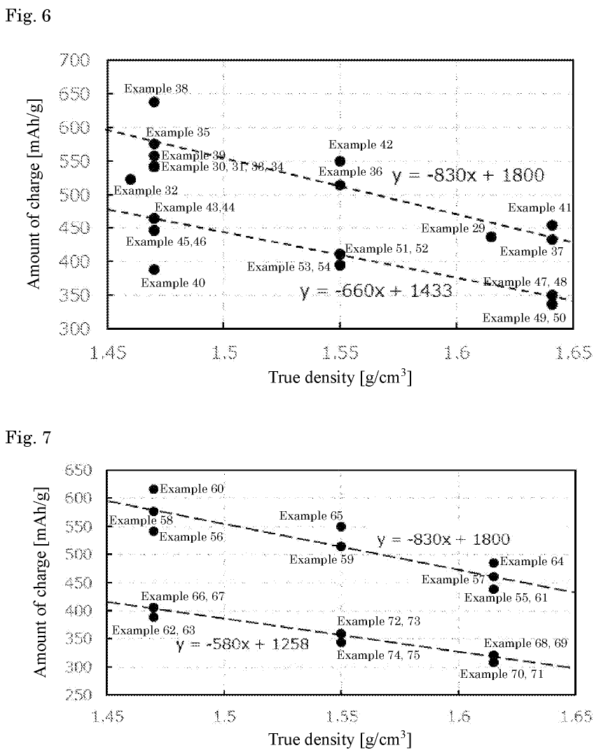

The following Table 2 shows the amount of charge of the negative electrode, the N/P ratio, the capacity retention ratio after the charge-discharge cycle, the evaluation of the capacity retention ratio, and the evaluation results of the porosity of the separator in each of Examples 29 to 54. FIG. 6 shows the relationship between the true density of the non-graphitized carbon in the negative active material and the amount of charge of the negative electrode in a fully charged state in Examples 29 to 54.

Table 2

| | True density [g/cm³] | Porosity of separator [%] | Upper limit of amount of charge y = -830A+1800 [mAh/g] | Amount of charge [mAh/g] | Lower limit of amount of charge y = -660A+1433 [mAh/g] | N/P ratio | Capacity retention ratio after 1000 cycles [%] | Amount of charge Equal to or less than y = -830A+1800 Equal to or greater than y = -660A+1433 Determination |
|---|---|---|---|---|---|---|---|---|
| Example 29 | 1.615 | 50 | 460 | 438 | 367 | 0.41 | 81 | Applicable |
| Example 30 | 1.470 | 50 | 580 | 541 | 463 | 0.33 | 81 | Applicable |
| Example 31 | 1.470 | 60 | 580 | 541 | 463 | 0.33 | 83 | Applicable |
| Example 32 | 1.460 | 50 | 588 | 523 | 469 | 0.34 | 82 | Applicable |
| Example 33 | 1.470 | 50 | 580 | 541 | 463 | 0.33 | 81 | Applicable |
| Example 34 | 1.470 | 50 | 580 | 541 | 463 | 0.33 | 81 | Applicable |
| Example 35 | 1.470 | 50 | 580 | 576 | 463 | 0.31 | 80 | Applicable |
| Example 36 | 1.550 | 50 | 514 | 514 | 410 | 0.35 | 80 | Applicable |
| Example 37 | 1.641 | 50 | 438 | 433 | 350 | 0.41 | 80 | Applicable |
| Example 38 | 1.470 | 50 | 580 | 638 | 463 | 0.28 | 71 | More than y = -830A+1800 |
| Example 39 | 1.470 | 48 | 580 | 558 | 463 | 0.32 | 75 | Applicable |
| Example 40 | 1.470 | 50 | 580 | 388 | 463 | 0.46 | 79 | Less than y = -660A+1433 |
| Example 41 | 1.641 | 50 | 438 | 455 | 350 | 0.39 | 72 | More than y = -830A+1800 |
| Example 42 | 1.550 | 50 | 514 | 550 | 410 | 0.33 | 73 | More than y = -830A+1800 |
| Example 43 | 1.470 | 50 | 580 | 464 | 463 | 0.37 | 79 | Applicable |
| Example 44 | 1.470 | 48 | 580 | 464 | 463 | 0.37 | 75 | Applicable |
| Example 45 | 1.470 | 50 | 580 | 447 | 463 | 0.39 | 78 | Less than y = -660A+ 1433 |
| Example 46 | 1.470 | 48 | 580 | 447 | 463 | 0.39 | 78 | Less than y = -660A+1433 |
| Example 47 | 1.641 | 50 | 438 | 350 | 350 | 0.49 | 78 | Applicable |
| Example 48 | 1.641 | 48 | 438 | 350 | 350 | 0.49 | 74 | Applicable |
| Example 49 | 1.641 | 50 | 438 | 337 | 350 | 0.52 | 78 | Less than y = -660A+1433 |
| Example 50 | 1.641 | 48 | 438 | 337 | 350 | 0.52 | 78 | Less than y = -660A+1433 |
| Example 51 | 1.550 | 50 | 514 | 411 | 410 | 0.41 | 78 | Applicable |
| Example 52 | 1.550 | 48 | 514 | 411 | 410 | 0.41 | 75 | Applicable |
| Example 53 | 1.550 | 50 | 514 | 395 | 410 | 0.43 | 77 | Less than y = -660A+1433 |
| Example 54 | 1.550 | 48 | 514 | 395 | 410 | 0.43 | 77 | Less than y = -660A+1433 |

As shown in Table 2 and FIG. 6, in Examples 29 to 37, 43, 47, and 51, when the true density of the non-graphitizable carbon was A [g/cm³], the amount of charge B [mAh/g] of the negative electrode in a fully charged state fell within the range of -660 × A + 1433 ≤ B ≤ -830 × A + 1800, and the porosity of the separator was 50% or more. In Examples 29 to 37, 43, 47, and 51, the capacity retention ratio after the charge-discharge cycle was good.

Meanwhile, in Examples 39, 44, 48, and 52 in which the amount of charge B [mAh/g] of the negative electrode was in the range of -660 × A + 1433 ≤ B ≤ -830 × A+ 1800, but the porosity of the separator was less than 50%, the capacity retention ratio decreased.

In Examples 40, 45, 46, 49, 50, 53, and 54 in which the amount of charge B [mAh/g] of the negative electrode was less than -660 × A + 1433, the capacity retention ratio was good regardless of the porosity of the separator.

Furthermore, in Examples 38, 41, and 42 in which the amount of charge B [mAh/g] of the negative electrode was more than -830 × A+ 1800, the capacity retention ratio decreased even though the porosity of the separator was 50% or more.

In the energy storage device, when the amount of charge B [mAh/g] of the negative electrode in the fully charged state falls within a specific range satisfying -660 × A + 1433 ≤ B ≤ -830 × A + 1800, it can be seen that the decrease in the capacity retention ratio can be suppressed by using the separator having a large porosity in combination even when the depth of charge is relatively large.

As a result, it was shown that the energy storage device can suppress the decrease in the capacity retention ratio after the charge-discharge cycle when the non-graphitizable carbon is used as the active material of the negative electrode having a large depth of charge.

### Examples 55 to 75

### Preparation of Negative Electrode

Non-graphitizable carbon as a negative active material, a styrene-butadiene rubber (SBR) as a binder, carboxymethyl cellulose (CMC) as a thickener, and water as a dispersion medium were mixed to prepare a negative composite paste. The mass ratio of the non-graphitizable carbon to the styrene-butadiene rubber (carboxymethyl cellulose (CMC)) was set to 97.4 : 2.0 : 0.6 in terms of solid content.

The negative composite paste was prepared by adjusting the amount of water to adjust the viscosity and mixing using a multi-blender mill. The negative composite paste was applied to both surfaces of a copper foil as a negative electrode substrate such that a non-layered portion was formed at one end edge of the copper foil. Next, a negative active material layer was produced by drying. After the drying, the negative active material layer was roll-pressed so as to have a predetermined packing density, thereby obtaining a negative electrode.

### (Preparation of Positive Electrode)

Lithium nickel cobalt manganese composite oxide as a positive active material, acetylene black (AB) as a conductive agent, polyvinylidene fluoride (PVDF) as a binder, and N-methylpyrrolidone (NMP) as a nonaqueous dispersion medium were used to prepare a positive composite paste (positive active material layer-forming material). The mass ratio of the positive active material, the binder, and the conductive agent was set to 94.5 : 4.0 : 1.5 in terms of solid content. The positive composite paste was applied to both surfaces of an aluminum foil as a positive electrode substrate such that a non-layered portion was formed at one end edge of the aluminum foil. Next, a positive active material layer was prepared by drying. After the drying, the positive active material layer was roll-pressed so as to have a predetermined packing density, thereby obtaining a positive electrode. The N/P ratios of Examples 55 to 75 are shown in Table 3. Here, the molar ratio of nickel, cobalt, and manganese (Ni : Co : Mn ratio) of the lithium nickel cobalt manganese composite oxide as the positive active material was set to 6.0 : 2.0 : 2.0.

### Nonaqueous Electrolyte

A nonaqueous electrolyte was prepared by dissolving LiPF₆ in a solvent in which propylene carbonate (PC) and diethyl carbonate (DEC) were mixed at a volume ratio of 30 : 70 so that a salt concentration was 1.2 mol/dm³.

### Separator

As a separator, a polyethylene microporous film having a thickness of 14 µm was used.

### Energy Storage Device

The positive electrode, the negative electrode, and the separator were layered to prepare an electrode assembly. Thereafter, the electrode assembly was enclosed in a case. Next, the case was welded to a lid plate. Then, the nonaqueous electrolyte was injected into the case, and a case opening was sealed. In this way, batteries (energy storage devices) of Examples 55 to 75 were obtained. The designed rated capacity of the battery is 40.9 Ah.

### Evaluation

### True Density of Non-Graphitized Carbon

The true density of the non-graphitizable carbon was measured by the above-described method.

### Amount of Charge of Negative Electrode

The amount of charge of the negative electrode was measured by the above-described method.

### DCR (Direct Current Resistance) Increase Rate After Charge-Discharge Cycle

### Initial Discharge Capacity Confirmation Test

Each energy storage device was subjected to constant current constant voltage (CCCV) charge until the charge current reached 0.4 A or less under the conditions of a charge current of 13.6 A and an end-of-charge voltage of 4.32 V in a thermostatic bath at 25° C., followed by a rest period of 20 minutes. Thereafter, constant current (CC) discharge was performed at a discharge current of 40.9 A and an end-of-discharge voltage of 2.4 V. A discharge capacity at this time was defined as “initial discharge capacity”.

### Charge-Discharge Cycle Test

Each energy storage device after the measurement of the “initial discharge capacity” was subjected to constant current constant voltage (CCCV) charge until the charge current reached 0.4 A or less under the conditions of a charge current of 13.6 A and an end-of-charge voltage of 4.32 V in a thermostatic bath at 45° C., followed by a rest period of 10 minutes. Subsequently, constant current (CC) discharge was performed at a discharge current of 40.9 A to an end-of-discharge voltage of 2.4 V, followed by a rest period of 10 minutes. This charge-discharge cycle was performed for 1000 cycles. After 1000 cycles, a discharge capacity was measured under the same conditions as those in the measurement test of the “initial capacity”, and the discharge capacity at this time was defined as “capacity after 1000 cycles”.

### DCR Increase Rate After Charge-Discharge Cycle

The DCR increase rate of the energy storage device after the charge-discharge cycle test was evaluated. Each of the energy storage devices after the measurement of the initial discharge capacity (before the start of the charge-discharge cycle test) and after the 1000 cycle test (after the charge-discharge cycle test) was subjected to constant current charge at a current value of 13.6 A in a thermostatic chamber at 25° C. for an amount of charge corresponding to 50% of the discharge capacity measured under the same conditions as those in the above discharge capacity measurement method. After the SOC of the battery was set to 50% under the above conditions, each energy storage device was discharged for 10 seconds at current values of 40.9 A, 81.8 A, 122.7 A, and 300.0 A, and from the graph of current-voltage performance obtained by plotting the voltage 10 seconds after the start of the discharge on the vertical axis and the discharge current value on the horizontal axis, a DCR value as a value corresponding to the slope was obtained. For each Test Example, the ratio of the “DCR after charge-discharge cycle test” to “the DCR before start of charge-discharge cycle test” (“DCR after charge-discharge cycle test”/“DCR before start of charge-discharge cycle test”) at 25° C. was calculated to determine the “DCR increase rate (%)”. For the DCR increase rate, the ratio [%] of the DCR increase rate of each Test Example to the DCR increase rate of Example 55 was determined.

Table 3 below shows the true density of the non-graphitized carbon of each of Examples 55 to 75, the counter cation of the cellulose derivative, the amount of charge of the negative electrode, the N/P ratio, and the ratio of the DCR increase rate of each of Test Examples to the DCR increase rate of Example 55. FIG. 7 shows the relationship between the true density of the non-graphitized carbon in the negative active material and the amount of charge of the negative electrode in a fully charged state in Examples 55 to 75.

Table 3

| Test Example No. | True density [g/cm³] | Cellulose derivative Counter cation | Upper limit of amount of charge y = -830A+1800 [mAh/g] | Amount of charge [mAh/g] | Lower limit of amount of charge y = -580A+1258 [mAh/g] | Amount of charge Equal to or less than y = -830A+ 1800 Equal to or greater than y = -580A+1258 Determination | N/P ratio | Ratio [%] of DCR increase rate after 1000 cycles to Example 1 |
|---|---|---|---|---|---|---|---|---|
| Example 55 | 1.615 | Sodium ion | 460 | 438 | 321 | Applicable | 0.41 | 100 |
| Example 56 | 1.470 | Sodium ion | 580 | 541 | 405 | Applicable | 0.33 | 102 |
| Example 57 | 1.615 | Sodium ion | 460 | 460 | 321 | Applicable | 0.39 | 108 |
| Example 58 | 1.470 | Sodium ion | 580 | 576 | 405 | Applicable | 0.31 | 106 |
| Example 59 | 1.550 | Sodium ion | 514 | 514 | 359 | Applicable | 0.35 | 107 |
| Example 60 | 1.470 | Sodium ion | 580 | 616 | 405 | Not applicable | 0.29 | 124 |
| Example 61 | 1.615 | Ammonium ion | 460 | 438 | 321 | Applicable | 0.41 | 182 |
| Example 62 | 1.470 | Sodium ion | 580 | 388 | 405 | Not applicable | 0.46 | 109 |
| Example 63 | 1.470 | Ammonium ion | 580 | 388 | 405 | Not applicable | 0.46 | 110 |
| Example 64 | 1.615 | Sodium ion | 460 | 485 | 321 | Not applicable | 0.37 | 134 |
| Example 65 | 1.550 | Sodium ion | 514 | 550 | 359 | Not applicable | 0.33 | 131 |
| Example 66 | 1.470 | Sodium ion | 580 | 406 | 405 | Applicable | 0.44 | 108 |
| Example 67 | 1.470 | Ammonium ion | 580 | 406 | 405 | Applicable | 0.44 | 121 |
| Example 68 | 1.615 | Sodium ion | 460 | 322 | 321 | Applicable | 0.56 | 105 |
| Example 69 | 1.615 | Ammonium ion | 460 | 322 | 321 | Applicable | 0.56 | 132 |
| Example 70 | 1.615 | Sodium ion | 460 | 308 | 321 | Not applicable | 0.58 | 106 |
| Example 71 | 1.615 | Ammonium ion | 460 | 308 | 321 | Not applicable | 0.58 | 108 |
| Example 72 | 1.550 | Sodium ion | 514 | 359 | 359 | Applicable | 0.51 | 109 |
| Example 73 | 1.550 | Ammonium ion | 514 | 359 | 359 | Applicable | 0.51 | 127 |
| Example 74 | 1.550 | Sodium ion | 514 | 344 | 359 | Not applicable | 0.53 | 110 |
| Example 75 | 1.550 | Ammonium ion | 514 | 344 | 359 | Not applicable | 0.53 | 111 |

As shown in Table 3 and FIG. 7, in Examples 55 to 59, 66, 68, and 72, when the true density of the non-graphitizable carbon was A [g/cm³], the amount of charge B [mAh/g] of the negative electrode in a fully charged state fell within the range of -580 × A + 1258 ≤ B ≤ -830 × A + 1800, and the negative active material layer contained the cellulose derivative in which the counter cation was the metal ion. In Examples 55 to 59, 66, 68, and 72, an effect of suppressing the DCR increase rate after the charge-discharge cycle was good.

Meanwhile, in Examples 61, 67, 69, and 73 in which the amount of charge B of the negative electrode was in the range of -580 × A + 1258 ≤ B ≤ -830 × A+ 1800, but the negative active material layer contained the cellulose derivative in which the counter cation was not the metal ion, an effect of suppressing an increase in resistance after the charge-discharge cycle was deteriorated.

In Examples 62, 63, 70, 71, 74, and 75 in which the amount of charge B of the negative electrode was less than -580 × A+ 1258, the DCR increase rate was good regardless of the kind of the counter cation of the cellulose derivative.

Furthermore, in Examples 60, 64, and 65 in which the amount of charge B of the negative electrode was more than -830 × A + 1800, although the negative active material layer contained the cellulose derivative in which the counter cation was the metal ion, the effect of suppressing the increase in resistance after the charge-discharge cycle was deteriorated.

In the energy storage device, when the amount of charge B of the negative electrode in the fully charged state falls within a specific range satisfying -580 × A+ 1258 ≤ B ≤ -830 × A+ 1800, it can be seen that the increase in resistance after the charge-discharge cycle can be suppressed by containing the cellulose derivative in which the counter cation is the metal ion even when the depth of charge of the negative electrode is relatively large.

As a result, it was shown that the energy storage device is excellent in an effect of suppressing the increase in resistance after the charge-discharge cycle when the non-graphitizable carbon is used as the active material of the negative electrode having a large depth of charge.

### INDUSTRIAL APPLICABILITY

The present invention is suitably used as an energy storage device including a nonaqueous electrolyte secondary battery used as a power source for electronic equipment such as personal computers and communication terminals, automobiles, and the like.

### DESCRIPTION OF REFERENCE SIGNS

1: energy storage device
2: electrode assembly
3: case
4: positive electrode terminal
5: negative electrode terminal
8: winding core
11: positive electrode
12: negative electrode
20: energy storage unit
21: positive electrode substrate
22: negative electrode substrate
23: negative active material layer
24: positive active material layer
25: separator
30: energy storage apparatus
31: positive electrode non-layered portion
32: negative electrode non-layered portion
41: positive current collector
51: negative current collector

1. An energy storage device comprising:
a negative electrode including a negative electrode substrate and a negative active material layer layered directly or indirectly on a surface of the negative electrode substrate; and
a positive electrode, wherein
the negative active material layer contains a negative active material;
the negative active material contains non-graphitizable carbon;
in one direction of the negative electrode substrate, at least one end edge side of the negative active material layer is thicker than a central portion present between the one end edge side and the other end edge side; and
when a true density of the non-graphitizable carbon is A [g/cm³], an amount of charge B [mAh/g] of the negative electrode in a fully charged state satisfies the following formula 1:
$$\text{-730} \times \text{A + 1588} \leq \text{B} \leq \text{-830} \times \text{A + 1800}$$

2. The energy storage device according to claim 1, wherein a thickness difference (T2-T1) between a thickness T2 of the negative active material layer on the one end edge side and a thickness T1 of the central portion is 1 µm or more and 5 µm or less.

3. The energy storage device according to claim 1, wherein
the negative electrode substrate includes a non-layered portion which protrudes from the one end edge side and on which the negative active material layer is not layered; and
a thickness T2 of the negative active material layer on the non-layered portion side is greater than a thickness T3 of the negative active material layer on the other end edge side.

4. The energy storage device according to claim 1, wherein
the positive electrode includes a positive electrode substrate and a positive active material layer directly or indirectly layered on a surface of the positive electrode substrate;
the positive active material layer contains a positive active material;
the positive active material contains a lithium transition metal oxide containing nickel, cobalt, and manganese as a main component; and
a molar ratio of nickel to a total of nickel, cobalt, and manganese in the lithium transition metal oxide is 0.5 or more.

5. The energy storage device according to claim 1 , further comprising a separator interposed between the negative electrode and the positive electrode, wherein the separator has a porosity of 50% or more.

6. The energy storage device according to claim 1 , wherein the non-graphitizable carbon has a true density A of 1.5 g/cm³ or less.

7. The energy storage device according to claim 1 , wherein the negative active material layer contains a cellulose derivative in which a counter cation is a metal ion.

8. The energy storage device according to claim 7, wherein the metal ion is a sodium ion.
